(19) United States
(12) Patent Application Publication
(10) Pub. No.: US 2022/0381345 A1
(43) Pub. Date: Dec. 1, 2022

(54) SEAL WITH BACK-UP RING

(71) Applicant: RUBBERATKINS LIMITED, Bridge of Don, Aberdeen (GB)

(72) Inventors: Stuart ROTHNIE, Aberdeen (GB); Ryan NISH, Aberdeen (GB); Matthew FRASER, Aberdeen (GB)

(21) Appl. No.: 17/770,606

(22) PCT Filed: Oct. 21, 2020
(86) PCT No.: PCT/EP2020/079638

§ 371 Date: Apr. 20, 2022

(30) Foreign Application Priority Data
Oct. 21, 2019 (GB) 1915202.4

(51) Int. Cl. F16J 15/16

(52) U.S. Cl. CPC F16J 15/166

(57) ABSTRACT

A back-up ring (1) for a gland seal includes at least two part ring portions (2,4). Each part ring portion comprises first (6, 10) and second (8, 12) ends. Each end has an undulating surface (22, 24) for overlapping in engagement with a corresponding undulating surface on an end of another part ring portion, to form the back-up ring (1). When the part ring portions (2,4) are assembled to form the back-up ring (1) and are held together by axial and/or radial compression, the engagement of the undulating surfaces (22, 24) restricts relative movement between the part ring portions. A seal assembly (34) including the back-up ring (1) is also disclosed.

### FIELD

The present invention relates to a back-up ring for seals and a seal including the back-up ring.

### BACKGROUND

Back-up rings find use in a wide variety of mechanical seals making use of one or more resiliently deformable sealing members (gaskets) to make sealing engagement between parts. Back-up rings are often employed in mechanical seals where two parts move one relative to the other but are also in sealing engagement with each other. For example where one part rotates inside another such as a rotating shaft passing through the wall of a pump containing fluid, or a piston moving in a cylinder. Back up-rings also find use in seals between parts that do not move with respect to each other.

Mechanical seals employing resiliently deformable sealing members and back-up rings may be generally described as gland seals. Seals between parts that move relative to each other and between parts that do not move relative to each other are both described as gland seals in this document.

A back-up ring is a ring of relatively non-deformable material having a hole therethrough. The ring typically fits into a groove or an adjacent groove to that of a resiliently deformable sealing member. When the sealing member is being subject to pressure and/or temperature stress the back-up ring acts to prevent the resiliently deformable sealing member squeezing out of the groove resulting in a failure mode for the seal, known as extrusion.

For example, 0 ring seals typically comprise a resiliently deformable ring (O ring), typically of an elastomer, typically of circular cross section, that locates into a circumferential groove of an article, with the ring protruding from the groove for sealing, in radial compression, with another article disposed about the circumference of the ring. Back up rings are used where the O ring may be subject to relatively high temperature and/or pressure, tending to displace the O ring axially from the groove, causing the seal to fail. Other types of gland seal where a back-up ring may be employed include those using other types of resiliently deformable sealing member, such as those known as U-seals, T-seals, and D-seals.

### SUMMARY

According to a first aspect of the invention there is provided a back-up ring for a gland seal comprising:

at least two part ring portions,
wherein each part ring portion comprises first and second ends, each end having an undulating surface for overlapping in engagement with a corresponding undulating surface on an end of another part ring portion, to form the back-up ring; and
wherein, when the part ring portions are assembled to form the back-up ring and are held together by axial and/or radial compression, the engagement of the undulating surfaces restricts relative movement between the part ring portions.

The engagement between the undulating surfaces restricts relative movement between the part ring portions i.e. the engagement between the undulating surfaces of the part ring portions acts to prevent the portions separating, but some relative movement between them can be acceptable; and may be allowed by the design of the undulating surfaces.

Each part ring portion has first and second ends each of which overlaps with an end of another part ring portion to allow engagement between the undulating surfaces.

In one convenient form of the back-up ring the undulating surfaces are axially facing undulating surfaces. By axially facing is meant facing generally in the same direction as the principal axis of the ring which is normal to the diameter of the ring. The axially facing undulating surfaces of the first and second ends of a ring portion may be formed on the same axially facing surface. Alternatively the undulating surface of the first end may be formed on an opposite axially facing surface to that of the second end, as discussed further hereafter and with reference to a specific embodiment. Axially facing undulating surfaces will tend to engage more strongly when the back-up ring is subjected to axial compression

In another convenient form of the back-up ring, the undulating surfaces are radially facing undulating surfaces. By radially facing is meant facing generally in the direction normal to the principal axis of the ring, either inwards toward the centre of the ring or outwards, away from the centre of the ring. The radially facing undulating surfaces of the first and second ends of a ring portion may be formed on the same facing surface i.e. both are facing radially outwards or both are facing radially inwards. Alternatively the undulating surface of the first end may be formed on an opposite facing surface to that of the second end, as discussed further hereafter and with reference to a specific embodiment. Radially facing undulating surfaces will tend to engage more strongly when the back-up ring is subjected to radial compression.

Conveniently the part ring portions are separate until placed together to form the back-up ring. The assembled ring will include a hole defined by the part ring portions, typically a circular hole. The hole in the back-up ring may typically be central. The circumferential outside edge of the ring may typically be circular. However other shapes for the hole and circumferential edge are contemplated for some applications, as are different positions for the hole. For example if a groove into which a resiliently deformable sealing member (such as an O ring) sits is non circular, then the hole in the ring may have a shape that corresponds.

Conveniently the back-up ring comprises only two part ring portions which form the back-up ring when placed together, with the undulating surfaces overlapping. Only two parts are required to form the ring. However, a back-up ring comprising more than two part ring portions (e.g. three) may be used in some circumstances.

Providing a back-up ring comprising at least two part ring portions that are overlapped in use to form the back-up ring can provide advantages. Conventional back up rings are one piece. If formed without a join (a split) then the conventional back-up ring must be sized and made of a suitable material to suit the intended use.

For example if a conventional one piece back-up ring is to be placed in a groove formed around the outside surface of a circular or cylindrical part such as a tubing, the one piece unsplit ring must pass over the outside surface. To fit snugly within the groove, the backup ring must be made of a material that is sufficiently resiliently deformable (stretchable) to allow it to stretch to pass over the outside surface of the tubing, and then relax or be forced into a snug fit in the groove. Such a back-up ring may not be sufficiently stiff to hold an associated O ring in place when subjected to relatively high pressure and temperature conditions.

Known split back up rings provide the opportunity of opening the ring, by distorting the ends of the ring to allow easier fitting. Thus back up rings of a metal may be split to allow fitting over a tubing and then re-joining or overlapping at the join. However the re-joining or overlapping may not be fully as intended. Therefore such an arrangement may present difficulties in some circumstances.

Distortion of a conventional back-up ring may not be completely reversible, potentially leading to uneven contact forces between the back-up ring and an associated sealing member, in use. Furthermore the choice of materials of construction for the back-up ring may be limited to materials that can be distorted and restored to, or near to, their former shape.

With a back-up ring of the invention the part ring portions can allow fitting a back-up ring of a relatively stiff and/or non-deformable material into a groove. Furthermore forming a back-up ring in a groove where access is limited can be easier where the back-up ring is in two (or more) parts. Each part can be applied separately to the groove and even slid around the groove into position, to allow formation of the complete ring.

A back-up ring of the invention may have a generally uniform thickness in the axial direction. In a typical sealing member and back-up ring assembly, and when using a back-up ring in accordance with the invention, the axially opposed surfaces of the ring (that typically engage with a sealing member, such as an O ring, and an axially facing surface of a groove respectively) are planar and parallel. The back-up ring may have a generally uniform thickness in the radial direction.

The ends of the part ring portions overlap circumferentially (i.e. the overlaps extend around part of the circumference of the ring) to allow engagement of the undulating surfaces in forming the ring. Therefore, where the ring has a uniform thickness in the axial direction, and the undulating surfaces are axially facing, the axial thickness of two overlapping part ring ends combine to provide the desired thickness.

Similarly where the back-up ring has uniform thickness in the radial direction and the undulating surfaces are radially facing, the radial thickness of two overlapping part ring ends may combine to provide the desired thickness.

Part ring portion ends that combine to form a uniform thickness (axially and/or radially) can be achieved in various ways. The ends of a part ring portion may be of a generally uniform thickness along the extent of the undulating surface, (apart from projections and depressions forming the undulations). When engaged with a corresponding end of another part ring portion a uniform thickness for the ring at the overlap can be obtained. Advantageously the first and second ends of a part ring portion may taper towards the extreme end e.g. each end of a part ring portion decreases in thickness from that of the assembled back up ring, until the extreme end of the part ring portion.

Conveniently the part ring portions making up a back-up ring are all the same. For example where only two part ring portions are employed two identical part ring portions may be employed, which when fitted together form the complete back up ring. Such arrangements allow e.g. any two part ring portions to be paired together to make a back-up ring, avoiding mis fitting, which may occur if part ring portions have different forms.

The undulating surface may take many forms to allow engagement between part ring portions. Advantageously the undulating surface at an end of one part ring portion fits snugly into the corresponding undulating surface at an end of another part ring portion.

More advantageously, the engaging undulating surfaces may closely correspond in shape so that there is a high degree of contact, even complete contact without spaces, between corresponding undulating surfaces when they are placed together. When under axial or radial compression such an arrangement can avoid the presence of points, or small localised regions, of high pressure between contacting surfaces. High pressure points or localised regions could lead to early failure of the back-up ring, especially if the material of construction is relatively brittle.

For ease of fitting together and resisting relative movement between part ring portions, it is convenient to have an undulating surface comprising or consisting of a series of projections and depressions (peaks and troughs) alternating circumferentially along the undulating surfaces of the part ring portions.

Where the undulating surfaces are axially facing, the peaks and troughs may extend generally radially i.e. each peak or trough may run from the outer circumferential edge of a part ring portion to the outer edge of the hole in the ring.

Where the peaks and troughs are radially facing the peaks and troughs may extend generally axially i.e. each peak or trough may run from one axially opposed surface of the ring to the other.

Peaks and troughs may have various cross sectional shapes, including square, rectangular, triangular or other sharp edged forms such as ‘saw toothed’.

However, to provide even pressure between the undulating surfaces when under axial and/or radial compression, as discussed above, it is advantageous if the peaks and troughs have smooth shape in cross section, for example of a waveform such as seen in rolling water waves.

In a particularly convenient form of the back-up ring, undulating surfaces are provided on axially facing surfaces of the first and second ends of part ring portions that taper (decrease) in thickness towards the extreme end; and the undulating surfaces have generally radially extending peaks and troughs, with a smooth shape in cross section. Advantageously there may be close to or complete contact between corresponding undulating surfaces of one part ring portion with the next when they are placed together to form the back-up ring. Such arrangements can provide a relatively easy to fit back-up ring. For example where only two part ring portions are provided, the first part ring portion can be located in a groove and the second part ring portion slid into place with its smooth undulating surfaces sliding over the corresponding undulating surfaces of the first part ring portion.

In another particularly convenient form of the back-up ring, undulating surfaces are provided on radially facing surfaces of the first and second ends of part ring portions that taper (decrease) in thickness towards the extreme end; and the undulating surfaces have generally axially extending peaks and troughs, with a smooth shape in cross section. Advantageously there may be close to or complete contact between corresponding undulating surfaces of one part ring portion with the next when they are placed together to form the back-up ring. Such arrangements can provide a relatively easy to fit back-up ring. For example where only two part ring portions are provided, the first part ring portion can be located in a groove and the second part ring portion slid into place with its smooth undulating surfaces sliding over the corresponding undulating surfaces of the first part ring portion.

A back-up ring of the invention may be formed of different materials such as metals, polymers and reinforced polymers. The back-up ring may be of a material that does not allow substantial distortion, at least in terms of stretching (elongation) before breaking.

Examples of suitable materials can include polymers such as polyaryletherketones (PAEK) and reinforced (e.g. fibre or filler particle reinforced) PAEK materials. Thus the use of materials such as poyetherketones (PEK), polyetheretherketones (PEEK), polyetherketoneketones (PEKK), and polyetherketoneetherketoneketone (PEKEKK) is contemplated. Products comprising or consisting of such materials and reinforced products comprising these materials are contemplated. Fibre reinforcing may be for example glass fibre and/or carbon fibre reinforcing. Particle reinforcing may be of glass particles.

The back-up rings of the invention can be formed of such materials for relatively demanding use. For example back-up rings in O ring or other gland seal arrangements that operate under high pressures such as 3000 psi to 5000 psi (20.68 MPa to 34.47 MPa) or even substantially higher. Relatively high temperatures (say up to 300° C. or even 400° C., or above) are also contemplated.

The back-up ring can form part of a seal assembly. Thus according to a second aspect the present invention also provides a seal assembly for a gland comprising:

a resiliently deformable sealing member; and

a back-up ring, wherein the back-up ring comprises at least two part ring portions,
wherein each part ring portion comprises first and second ends, each end having an undulating surface for overlapping in engagement with a corresponding undulating surface on an end of another part ring portion, to form the back-up ring; and
wherein, when the part ring portions are assembled to form the back-up ring and are held together by axial and/or radial compression, the engagement of the undulating surfaces restricts relative movement between the part ring portions.

The back-up ring of the seal assembly may include any of the features described herein for a back-up ring in accordance with the first aspect of the invention.

The seal assembly may be provided with two back-up rings, one to either side of the resiliently deformable sealing member. The resiliently deformable sealing member may be provided fitted into a circumferential groove of an article such as a tubular article.

The groove may be around the outer circumference of an article or around an inner circumference of the article, for sealing contact with another part of an assembly.

The back-up ring or rings may be provided in the same groove as the resiliently deformable sealing member or in a different, adjacent, groove or grooves.

### BRIEF DESCRIPTION OF THE DRAWINGS

FIGS. 1A and 1B show a back-up ring in schematic elevation and plan views respectively;

FIG. 2 shows, in schematic cross section, the use of a seal assembly including a back-up ring;

FIGS. 3A, 3B, and 3C show in schematic cross section the ends of part ring portions;

FIG. 4A shows in plan view a part ring portion for a back-up ring;

FIG. 4B shows in plan view a back-up ring using the part ring portion of FIG. 4A; and

FIGS. 5A and 5B show back up rings in schematic perspective views.

### DETAILED DESCRIPTION OF THE DRAWINGS

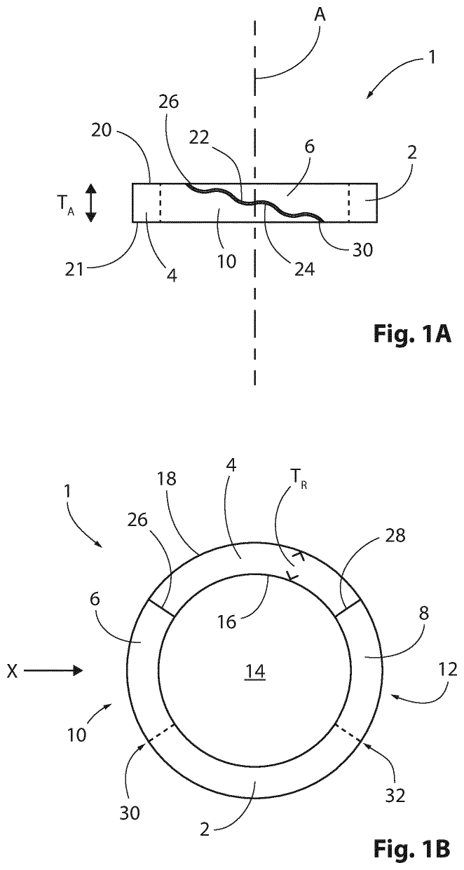

A back-up ring 1 is shown in schematic elevation in FIG. 1A and schematic plan view in FIG. 1B. FIG. 1A views the back-up ring of FIG. 1B in direction X. Referring to these figures the back-up ring 1 is formed of part ring portions 2,4. The first part ring portion 2 has first and second ends 6,8 and the second part ring portion 4 has first and second ends 10,12. A circular hole 14 having a circumference 16 is defined by the part ring portions as is the outer circumferential edge 18 of the back-up ring 1.

The back-up ring 1 has a principal axis A shown in FIG. 1A, normal to the diameter of the ring. The back-up ring 1 has a uniform axial thickness TA defined by the axially opposed surfaces 20,21 (upper and lower surfaces as depicted) which are planar and parallel in this example. The back-up ring has a uniform radial thickness TR.

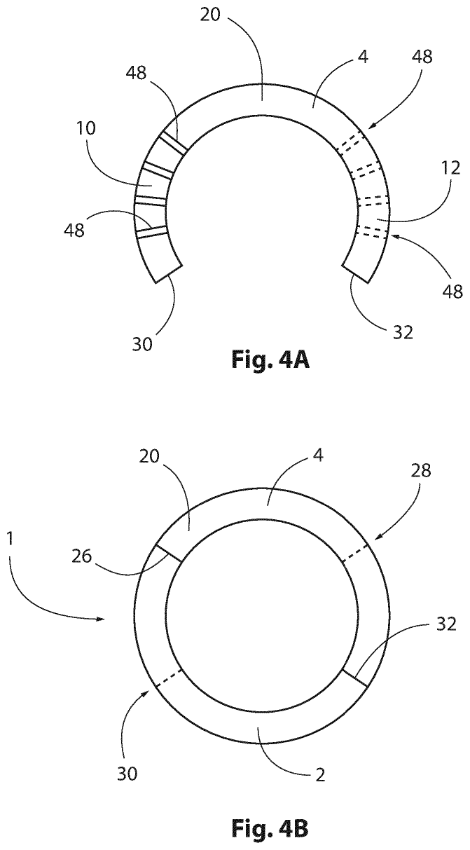

The first and second ends 6,8,10,12 of the part ring portions 2,4 have smooth undulating axially facing surfaces that engage with each other so as to be fully in contact, without spaces in between in this example. Two of the undulating surfaces 22,24 are visible in FIG. 1A. The peaks and troughs of the undulating surfaces are smooth in cross section and are radially extending (see FIG. 4A).

In this example the first and second ends 6,8,10,12 of the part ring portions 2,4 taper, getting thinner as they extend to their extreme ends 26,28,30,32.

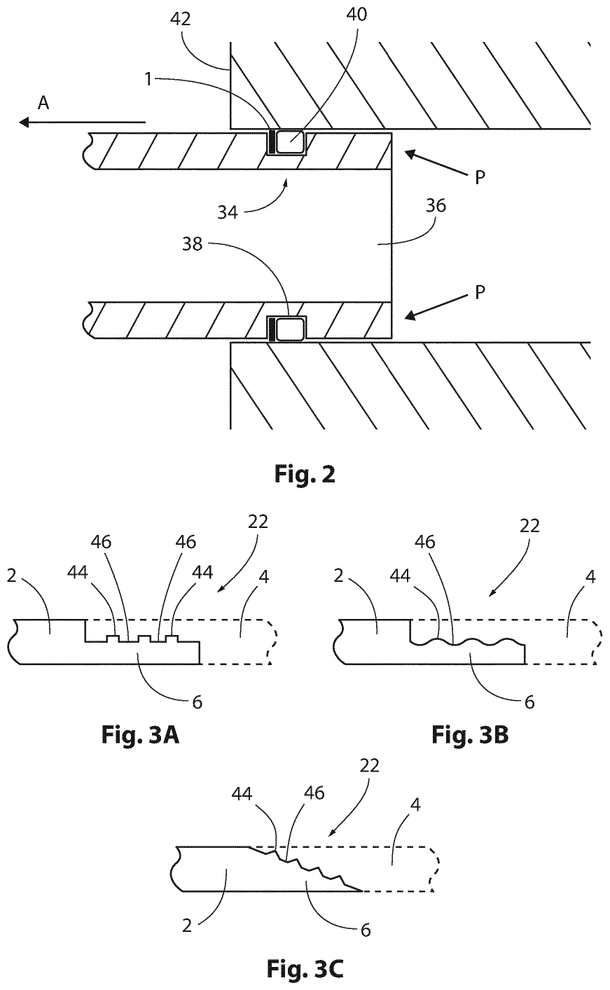

FIG. 2 shows in schematic cross section view the use of a back-up ring 1 in an O ring assembly 34. A tubular 36 has an external circumferential groove 38 into which an elastomeric O ring 40 has been fitted. The O ring 40 is compressed into sealing contact with a larger tubular 42 fitting around the tubular 36. Back up ring 1 is provided in the groove 38 to prevent axial (direction A) extrusion of the O ring 40 from its groove 38 when subjected to pressure P.

FIGS. 3A, 3B and 3C show some alternative undulating surface arrangements in partial elevation views of an end 6 of part ring portions 2. In each case the undulating surfaces comprise radially extending peaks 44 and troughs 46. As depicted the dashed line indicates the general outline of another part ring portion 4 that would have an end to overlap with and engage the undulating surfaces 22 depicted.

In FIG. 3A generally square or rectangular in cross section peaks and troughs are employed in the undulating surface 22 of an end 6 that otherwise has a uniform thickness i.e. the end 6 is not tapered.

A similar arrangement is shown in FIG. 3B except that the undulating surface 22 has smooth peaks and troughs 44,46.

In FIG. 3C the undulating surface 22 has triangular “teeth” as peaks 44. The end 6 is tapered in this example.

FIG. 4A shows a part ring portion 4 in plan view and FIG. 4B shows a back-up ring 1 formed of two part ring portions 2,4 made up from two part ring portions identical to that shown in FIG. 4A.

In this example the part ring portions 2,4 take the same general form as those depicted in FIGS. 1A and 1B except that the axially facing undulating surfaces of the first and second ends are on opposite axially facing surfaces. In the view FIG. 4A, first end 10 has the undulating surface 24 uppermost and second end 12 has the undulating surface 24 beneath. The peaks on these surfaces are suggested by the pairs of lines 48 (not shown in FIG. 4B).

Thus when the two part ring portions 4,2 are assembled as depicted in FIG. 4b the extreme ends 26,32 visible on upper surface 20 are diametrically opposite on the back-up ring 1.

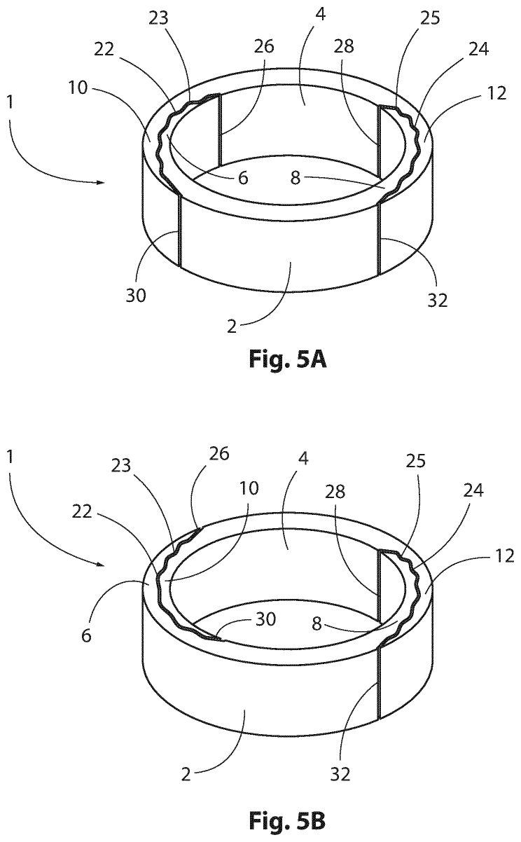

FIGS. 5A, and 5B show in schematic perspective, alternative back-up rings 1. In these rings the undulating surfaces are provided on radially facing surfaces of the first and second ends of part ring portions that taper (decrease) in thickness towards the extreme end.

In FIG. 5A a back-up ring 1 comprises two part ring portions 2,4. The part ring portions 2,4 have first and second ends 6,8,10,12. In this example the ends taper to the extreme ends 26,28,30,32 like those in the back-up ring of FIG. 1, but the undulating surfaces 22, 23,24,25 are radially facing. In FIG. 5A the undulating surfaces 22,25 of the first part ring portion 2 are both radially facing outwards (away from the centre of the ring) and extend axially. The undulating surfaces 23,24 of the second part ring portion 4 are both radially facing inwards (towards the centre of the ring) and extend axially. Part ring portions in FIG. 5A therefore have different forms, that complement each other to form the back-up ring 1.

In FIG. 5B a back-up ring 1 comprises two part ring portions 2,4. The part ring portions 2,4 have first and second ends 6,8,10,12. In this example the ends taper to the extreme ends 26,28,30,32 like those in the back-up ring of FIG. 1, but the undulating surfaces 22, 23,24,25 are radially facing. In FIG. 5B one of the undulating surfaces 25 of the first part ring portion 2 is radially facing outwards and the other 22 is radially facing inwards. The undulating surfaces 23,24 of the second part ring portion 4 are also facing one (24) radially inwards and the other (23) radially outwards. Part ring portions 2,4 in FIG. 5B have the same shape and can be used interchangeably.

1. A back-up ring for a gland seal comprising:
at least two part ring portions,
wherein each part ring portion comprises first and second ends, each end having an axially facing undulating surface for overlapping in engagement with a corresponding axially facing undulating surface on an end of another part ring portion, to form the back-up ring; and
wherein, when the part ring portions are assembled to form the back-up ring and are held together by axial and/or radial compression, the engagement of the undulating surfaces restricts relative movement between the part ring portions.

2. The back-up ring of claim 1 wherein the back-up ring comprises only two part ring portions.

3. (canceled)

4. The back-up ring of claim 1 wherein the undulating surfaces of the first and second ends of each ring portion are formed on the same axially facing surface of the respective part ring portion.

5. The back-up ring of claim 1 wherein the axially facing undulating surfaces of the first and second ends of each ring portion are formed on opposite axially facing surfaces of the respective part ring portion.

6. (canceled)

7. (canceled)

8. (canceled)

9. The back-up ring of claim 1 wherein the assembled back-up ring has a uniform thickness in the axial direction.

10. The back-up ring of claim 1 wherein the assembled back-up ring has a uniform thickness in the radial direction.

11. The back-up ring of claim 9 wherein the axially opposed surfaces of the ring are planar and parallel to each other.

12. The back-up ring of claim 1 wherein the first and second ends of each part ring portion are of a uniform thickness along their length, apart from projections and depressions forming the undulations of the undulating surfaces.

13. The back-up ring of claim 1 wherein each first and second end of each part ring portion tapers towards its respective extreme end.

14. The back-up ring of claim 1 wherein each part ring portion forming the back-up ring is identical to the other or others.

15. The back-up ring of claim 1 wherein the undulating surfaces that overlap in engagement have complete contact, without spaces in between.

16. The back-up ring of claim 1 wherein each undulating surface comprises or consists of a series of peaks and troughs alternating circumferentially along the undulating surfaces of the at least two part ring portions.

17. The back-up ring of claim 16 wherein the axially facing undulating surfaces have peaks and troughs that extend generally radially from the outer circumferential edge of a respective part ring portion to the outer edge of a hole in the ring.

18. (canceled)

19. The back-up ring of claim 16 wherein the peaks and troughs have smooth shape in cross section.

20. The back-up ring of claim 1 wherein the part ring portions comprise a polyaryletherketone (PAEK) or a reinforced polyaryletherketone material.

21. The back-up ring of claim 20 wherein the part ring portions comprise one or more of:
a polyetherketone (PEK); a polyetheretherketone (PEEK); a polyetherketoneketone (PEKK); and a polyetherketoneetherketoneketone (PEKEKK).

22. A seal assembly for a gland comprising:
a resiliently deformable sealing member; and
a back-up ring,
wherein the back-up ring comprises at least two part ring portions,
wherein each part ring portion comprises first and second ends, each end having an axially facing undulating surface for overlapping in engagement with a corresponding axially facing undulating surface on an end of another part ring portion, to form the back-up ring; and
wherein, when the part ring portions are assembled to form the back-up ring and are held together by axial and/or radial compression, the engagement of the undulating surfaces restricts relative movement between the part ring portions.

23. A part ring portion for a back-up ring for a gland seal comprising first and second ends, each end having an axially facing undulating surface for overlapping in engagement with a corresponding axially facing undulating surface on an end of another part ring portion, to form the back-up ring in use.
